(19) United States
(12) Patent Application Publication
(10) Pub. No.: US 2026/0339638 A1
(43) Pub. Date: Oct. 29, 2026

(54) COMPONENT-LEVEL MODULE RECOVERY IN STORAGE DEVICE

(71) Applicant: Sandisk Technologies, Inc., Milpitas, CA (US)

(72) Inventors: NITHIN KHILEDAAR, Bangalore (IN); RAMANATHAN MUTHIAH, Bangalore (IN); RAJESH NEERMARGA, Bangalore (IN)

(73) Assignee: Sandisk Technologies, Inc., Milpitas, CA (US)

(21) Appl. No.: 19/187,346

(22) Filed: Apr. 23, 2025

(51) Int. Cl. G06F 8/61

(52) U.S. Cl. CPC G06F 8/61

(57) ABSTRACT

A storage device may recover a first module without affecting other modules. The storage device includes multiple independent modules with at least one associated watchdog timer and a memory to store firmware associated with independent modules separately. A drive controller and/or a second independent module may receive an interrupt signal from a watchdog timer associated with the first independent module. The drive controller and/or a second independent module may determine that failure occurred on the first independent module such that the first independent module has to be reinitialized. The drive controller and/or a second independent module may reflash firmware associated with the first independent module to recover the first independent module from a failure state without reloading and executing firmware associated with other independent modules that have not experienced failure.

### BACKGROUND OF THE INVENTION

A storage device may be communicatively coupled to a host and to non-volatile memory including, for example, a NAND flash memory device on which the storage device may store data received from the host. The storage device may include multiple independent hardware modules with corresponding firmware. For example, the storage device may include a flash translation layer (FTL) that manages operations on the memory device, a Power Management Integrated Circuit (PMIC) that converts the host voltage into the smaller, regulated voltages needed by internal component on the storage device, a bridge chip that may facilitate communication between different interfaces between the storage device and the host, particularly in portable or external storage devices, etc. When one of these independent components malfunctions due, for example, to firmware corruption, the storage device may not function as desired. For example, if one of these independent components malfunction, the storage device may go into an unresponsive (brick) state and may cease to communicate with the host.

In some cases, the storage device may recover after a power reset. However, in some cases the storage device may not recover after a power reset. There is currently no way for the storage device to identify an independent component that has failed and report the failure to the host or auto recover the module-specific firmware associated with the failed component. When the storage device enters a brick state, the storage device may be replaced and may eventually end up as electronic waste.

### SUMMARY OF THE INVENTION

In some implementations, a storage device may recover a first module without affecting other modules. The storage device includes multiple independent modules with at least one associated watchdog timer and a memory to store firmware associated with independent modules separately. A drive controller and/or a second independent module may receive an interrupt signal from a watchdog timer associated with the first independent module. The drive controller and/or a second independent module may determine that failure occurred on the first independent module such that the first independent module has to be reinitialized. The drive controller and/or a second independent module may reflash firmware associated with the first independent module to recover the first independent module from a failure state without reloading and executing firmware associated with other independent modules that have not experienced failure.

In some implementations, a method is provided on the storage device for recovering a first module without affecting other modules. The method includes receiving an interrupt signal from a watchdog timer associated with a first independent module. The method also includes determining that failure occurred on the first independent module such that the first independent module has to be reinitialized. The method further includes reflashing firmware associated with the first independent module to recover the first independent module from a failure state without reloading and executing firmware associated with other independent modules that have not experienced failure.

In some implementations, a storage device may recover a first module without affecting other modules. The storage device includes multiple independent modules with at least one associated watchdog timer and a memory to store firmware associated with independent modules separately. A drive controller and/or a second independent module may receive an interrupt signal from a watchdog timer associated with the first independent module. The drive controller and/or a second independent module may determine that failure occurred on the first independent module. The drive controller and/or a second independent module reset or reflash an operating firmware and/or a diagnostic firmware for the first independent module to recover the first independent module from a failure state without reloading and executing firmware associated with other independent modules that have not experienced failure.

### BRIEF DESCRIPTION OF THE DRAWINGS

FIG. 1 is a schematic block diagram of an example system in accordance with some implementations.

FIG. 2 is another block diagram of an EEPROM used in accordance with some implementations.

FIG. 3 is an example flow diagram for recovering from failure at an independent module on a storage device used in accordance with some implementations.

FIG. 4 is an example flow diagram for diagnosing failure at an independent module on a storage device used in accordance with some implementations.

FIG. 5 is an example flow diagram for determining which thread of an independent module has a failure in accordance with some implementations.

FIG. 6 is an example flow diagram for resolving inter-dependency among the sub-components in accordance with some implementations.

FIG. 7 is a diagram of an example environment in which systems and/or methods described herein are implemented.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

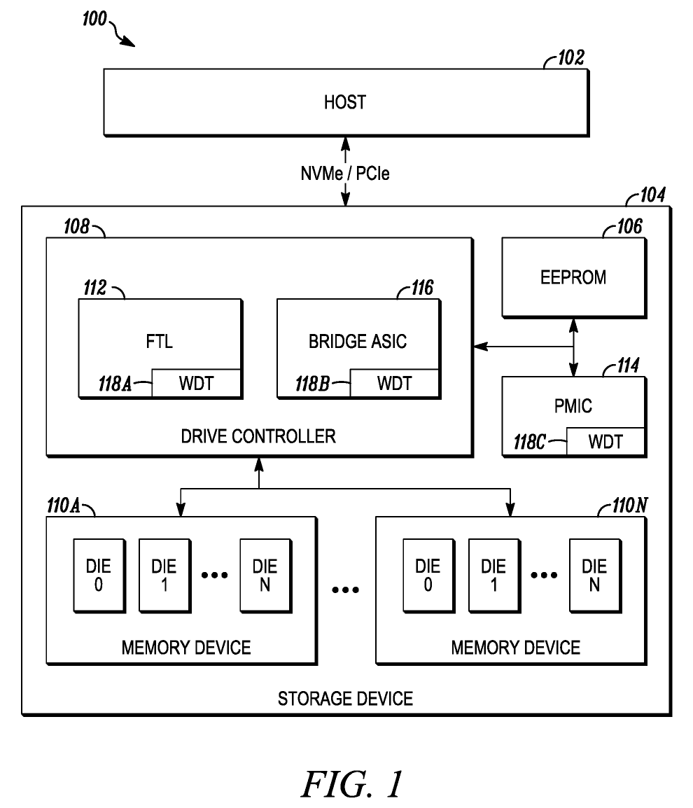

FIG. 1 is a schematic block diagram of an example system in accordance with some implementations. System 100 may include a host 102 and a storage device 104 that may be in the same physical location as components on a single computing device or on different computing devices that are communicatively coupled. Storage device 104 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage device 104 may be, for example, a solid-state drive (SSD) that may include an Electrically Erasable Programmable Read-Only Memory (EEPROM) 106, a drive controller 108, and one or more storage components such as non-volatile memory devices 110a-110n (referred to herein as the memory device(s) 110). In an implementation, storage device 104 may be a compute-storage device 104 that may include more than one compute cores (not shown). As such, storage device 104 may include more than one processing units within drive controller 108 to ensure efficient data transfer and storage. Each compute core may operate independently of other compute cores. EEPROM 106 may be, for example, non-volatile memory used to store firmware tables, operating firmware, diagnostic firmware, and/or other critical data that may remain intact even when power to storage device 104 is off.

Storage device 104 may also include one or more independent sub-components including, for example, a flash translation layer (FTL) 112, a Power Management Integrated Circuit (PMIC) 114 and a bridge Application-Specific Integrated Circuit (ASIC) 116. FTL 112 may manage operations on memory device 110. PMIC 114 may convert the host voltage into the smaller, regulated voltages needed by internal component on storage device 104. Bridge ASIC 116 may facilitate communication between different interfaces between the storage device and the host. Each of the independent sub-components may have associated independent hardware with corresponding controller/firmware that controls the functions of the sub-component. For example, FTL 112 may include FTL hardware component(s) and a FTL controller/firmware, PMIC 114 may include PMIC hardware component(s) including sensors and a PMIC controller/firmware, and bridge ASIC 116 may include a bridge controller/firmware. As such, each independent sub-component may be executed independently from other independent sub-components.

Drive controller 108 may interface with host 102 and process foreground operations including instructions transmitted from host 102. For example, drive controller 108 may read data from and/or write to memory devices 110 based on instructions received from host 102. Drive controller 108 may also execute background operations to manage resources on memory device 110. For example, drive controller 108 may monitor memory devices 110 and may execute garbage collection and other relocation functions per internal relocation algorithms to refresh, recycle, and/or relocate the data on memory devices 110.

Memory devices 110 may be flash based. For example, memory devices 110 may be a NAND or NOR flash memory that may be used for storing host and control data over the operational life of memory devices 110. Memory devices 110 may include one or more dies (i.e., DIE 1-DIE N) connected to a memory bus including data lines and chip enable lines. Memory devices 110 may save data in blocks in various formats, with the formats being defined by the number of bits that may be stored per memory cell. Memory device 110 may be included in storage device 104 or may be otherwise communicatively coupled to storage device 104.

In an implementation, firmware for sub-component(s) or compute core(s) (referred to generally as modules or independent modules) on storage device 104 that function independently may be segregated. For example, FTL firmware run by the FTL controller, PMIC firmware run by the PMIC controller, bridge firmware run by the bridge controller, and firmware for each independent compute core may be segregated from each other and stored as separate firmware. EEPROM 106 may include one or more firmware tables to provide the location of the firmware associated with an independent module.

For example, EEPROM 106 may include a table that points to the location of FTL firmware and/or includes the FTL firmware used in normal/ordinary FTL operations (referred to herein as operating FTL firmware), and a table that points to the location of diagnostic FTL firmware and/or includes the diagnostic FTL firmware that may be used to diagnose a problem on FTL 112. EEPROM 106 may also include a table that points to the location of PMIC firmware and/or includes the PMIC firmware used in normal/ordinary PMIC operations (referred to herein as operating PMIC firmware), and a table that points to the location of diagnostic PMIC firmware and/or includes the diagnostic PMIC firmware that may be used to diagnose a problem on PMIC 114. EEPROM 106 may also include a table that points to the location of bridge ASIC firmware and/or includes the bridge ASIC firmware used in normal/ordinary bridge ASIC operations (referred to herein as operating bridge firmware), and a table that points to the location of diagnostic bridge ASIC firmware and/or includes the diagnostic bridge ASIC firmware that may be used to diagnose a problem on bridge ASIC 116. EEPROM 106 may further include a table that points to the location of compute core firmware and/or includes the compute core firmware used in normal/ordinary operations (referred to herein as operating compute core firmware) for each compute core, and a table that points to the location of diagnostic compute core firmware and/or includes the diagnostic compute core firmware that may be used to diagnose a problem on the associated compute core. Diagnostic firmware for an independent module may collect details of failure at the independent module. Execution of diagnostic firmware usage may be optional based on the diagnostic requirements.

In some cases, the firmware state machine for an independent module may change and may not function/recover with a normal/power reset. If the firmware, for example, for a first independent module is in a state machine, such as a read-only mode, where it cannot recover even from a normal reset, then a reset of the independent module may cause storage device 104 to start in read-only mode. In these cases, storage device 104 may reflash (reload/reinstall and execute) firmware for the first independent module to recover from the failure state. Drive controller 108 and/or another independent module may detect that the first independent module has gone bad and drive controller 108 and/or the other independent module may determine if a reset or a reflash of operating and/or diagnostic firmware associated with the first independent module is required and accordingly execute that flow, without reloading and executing firmware associated with other independent modules that have not experienced failure.

Storage device 104 may include one or more watchdog timers (WDT), three of which are shown as 118a-118c (generally referred to herein as watchdog timer(s) 118). Watchdog timer 118 may be used to monitor associated microcontroller programs to determine if they are out of control or have stopped operating. As such, watchdog timers 118 may monitor the health and performance independent modules such as FTL 112, PMIC 114, bridge ASIC 116 or independent compute cores. A watchdog logic associated with watchdog timer 118 may be periodically reset watchdog timer 118 to determine the status of the associated microcontroller program. When watchdog timer 118 reports a High status using OR logic, watchdog timer 118 may determine that failure or freeze occurred at the associated independent module (referred to herein as the first independent module) and watchdog timer 118 may send an interrupt signal to one or more other independent modules. For example, watchdog timer 118 may send an interrupt signal to drive controller 108 and another independent module so that firmware reflash for the first independent module associated with the interrupt signal may be initiated.

In an implementations, when watchdog timer 118 detects potential issues such as failure or freeze at the first independent module and sends an interrupt signal to drive controller 108 and/or another/second independent module, drive controller 108 and/or the second independent module may obtain the firmware associated with the first independent module from EEPROM 106 and reload the firmware associated with the first independent module. Drive controller 108 and/or the second independent module may execute the firmware associated with the first independent module to reinitialize the first independent module and prevent storage device 104 from entering a brick state. The firmware associated with the first independent module may be reloaded and executed on storage device 104, without reloading and executing firmware associated with other sub-components or compute cores that have not experienced failure.

In some cases, drive controller 108 and/or the second independent module may obtain and execute/reinitialize the diagnostic firmware associated with the first independent module prior to obtaining and executing/reinitializing the operating firmware associated with the first independent module. In this way, there may be a log of the diagnosis of the failure on the first independent module. In some cases, drive controller 108 and/or the second independent module may obtain and execute/reinitialize the operating firmware associated with the first independent module without running the associated diagnostic firmware. If, after executing the operating firmware of the first independent module there is still failure on the first independent module, drive controller 108 and/or second independent module may obtain and execute the diagnostic firmware associated with the first independent module to provide a diagnosis of the failure on the first independent module.

An independent module may run multiple threads, and the independent module may interface/interact with other independent modules using different threads. For example, PMIC 114 may include multiple sensors that may be distributed throughout storage device 104. Each sensor may be associated with a watchdog timer (referred to as a thread watchdog timer 118), or a set of sensors may be associated with a thread watchdog timer 118. As such, thread watchdog timer(s) 118 associated with PMIC 114 may be placed at multiple sites on storage device 104. In another example, an independent compute core may run multiple threads, and the compute core may interface with other independent module using different threads. Each of the independent compute core threads may have an associated firmware that may be associated with a thread watchdog timer 118, or the firmware on a set of threads may be associated with a thread watchdog timer 118. As such, watchdog timer(s) 118 associated with the compute core may be placed at multiple sites on storage device 104. By executing thread watchdog timer(s) 118 of a first independent module at multiple sites and monitoring which thread watchdog timer(s) 118 associated with the first independent module has triggered an interrupt signal and which have not, another/second independent module and/or drive controller 108 may determine which firmware thread for the first independent module has failed so that the second independent module and/or drive controller 108 may perform error logging and/or recovery of the first module. Drive controller 108 may trigger other remedial actions such as data logging, recovering, and protecting host data based on determining which thread watchdog timer triggered the interrupt signal for the first independent module, thereby fine-tuning recovery mechanisms based on the actual component failure.

In an example storage device 104 may be configured as a compute-storage device and include more than one compute cores. As noted, each compute core may operate independently of other compute cores and may have one or more associated watchdog timers 118. Watchdog timer(s) 118 associated with a first compute core (referred to herein as first watchdog timer(s) 118) may provide watchdog status to, for example, a second compute core and/or the FTL controller. If one of watchdog first timer(s) 118 sends an interrupt signal to the second compute core and/or the FTL controller, the second compute core or the FTL controller may trigger a reset of the first compute core as a part of the system watchdog recovery, without impacting the workloads of other sub-components or compute cores. The second compute core or the FTL controller may also trigger logging of events associated with the first compute core. In some cases, the second compute core or the FTL controller may download the firmware used to run the first compute core and may reinstall the firmware used to run the first compute core. In some cases, the second compute core of the FTL controller may download a diagnostic firmware associated with the first compute core to generate a detailed report of the status of the first compute core.

In an example involving data protection and security, when drive controller 108 determines that watchdog timer 118 that is associated with a security processor/module (not shown) that operates as an independent component (referred to as a security core) has triggered an interrupt signal, drive controller 108 may direct the FTL controller to execute additional FTL steps to protect the security core data in memory device 110. Drive controller 108 may thus enable a faster response to a crash associated with the security core. In an example, when watchdog timer 118 associated with the security core triggers the watchdog interrupt signal, the FTL controller may freeze data access, freeze data decryption, create a redundant copy of some stored data, and/or halt some writes or reads until a threshold time or a system recovery state based on system preconditions associated to a security core crash.

To resolve the inter-dependency among the independent modules, one or more processors from one or more independent module(s) (referred to herein as a monitoring module(s)) may monitor the state of one or more other independent module(s) (referred to herein as a monitored module(s)). The monitoring module(s) may watch out for the state machine of the monitored module(s) by monitoring watchdog timer 118 associated with the monitored module(s). When watchdog timer 118 for a monitored module sends an interrupt signal, the monitoring module(s) may trigger system-wide watchdog logic to determine the best possible recovery modes. For example, bridge ASIC 116 may have multiple components that may be dispersed throughout sites on storage device 104. The bridge controller may have multiple watchdog timers 118, wherein one of the bridge controller watchdog timers 118 may be in each bridge ASIC 116 component. When a bridge controller watchdog timer 118 sends an interrupt signal from any site on storage device 104, bridge controller watchdog timer 118may lead storage device 104 to reset the firmware associated with bridge ASIC 116. The bridge controller may reset the watchdog timers 118 in each site through different flows to indicate that the bridge ASIC state machine is intact and functional.

Drive controller 108 may manage firmware images for individual independent module in EEPROM 106. Drive controller 108 may also manage one or more firmware tables that associate a firmware image with an independent module. Drive controller 108 may track the firmware states for independent module to determine if an interrupt signals has been received from watchdog timer 118 associated with any of the independent modules. If drive controller 108 determines that watchdog timer 118 associated with an independent module has sent an interrupt signal (i.e., the independent module has entered a system watchdog state machine), drive controller 108 may use the firmware table to identify the firmware that corresponds with the independent module that has entered a system watchdog state machine. Drive controller 108 may download the corresponding diagnostic and/or operating firmware associated with the independent module that has entered the system watchdog state machine from EEPROM 106 and execute the downloaded firmware to reinstall the independent module to recover storage device 104 from a potentially unresponsive state. Watchdog timers 118 may thus be used to establish an exact failure point in an independent module, such that another independent module on storage device 104 may execute the appropriate firmware that is suited to the failure condition.

Storage device 104 may perform these processes based on one or more processors, for example, drive controller 108 (and other components on storage device 104 including FLT 112, PMIC 114, bridge ASIC 116, etc.) executing software instructions stored by a non-transitory computer-readable medium, such as a storage component that may be, for example, memory device 110 and/or EEPROM 106. As used herein, the term “computer-readable medium” refers to a non-transitory memory device. Software instructions may be read into the storage component from another computer-readable medium or from another device. When executed, software instructions stored in the storage component may cause one or more processors, for example, drive controller 108 (and other components on storage device 104 including FLT 112, PMIC 114, bridge ASIC 116, etc.) to perform one or more processes described herein. Additionally, or alternatively, hardware circuitry may be used in place of or in combination with software instructions to perform one or more processes described herein. For example, the processes described herein may be executed by various components of drive controller (and other components on storage device 104 including FLT 112, PMIC 114, bridge ASIC 116, etc.), such as processors, logic gates, switches, application specific integrated circuits (ASICs), programmable logic controllers, embedded microcontrollers, and other components of drive controller (and other components on storage device 104 including FLT 112, PMIC 114, bridge ASIC 116, etc.). Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

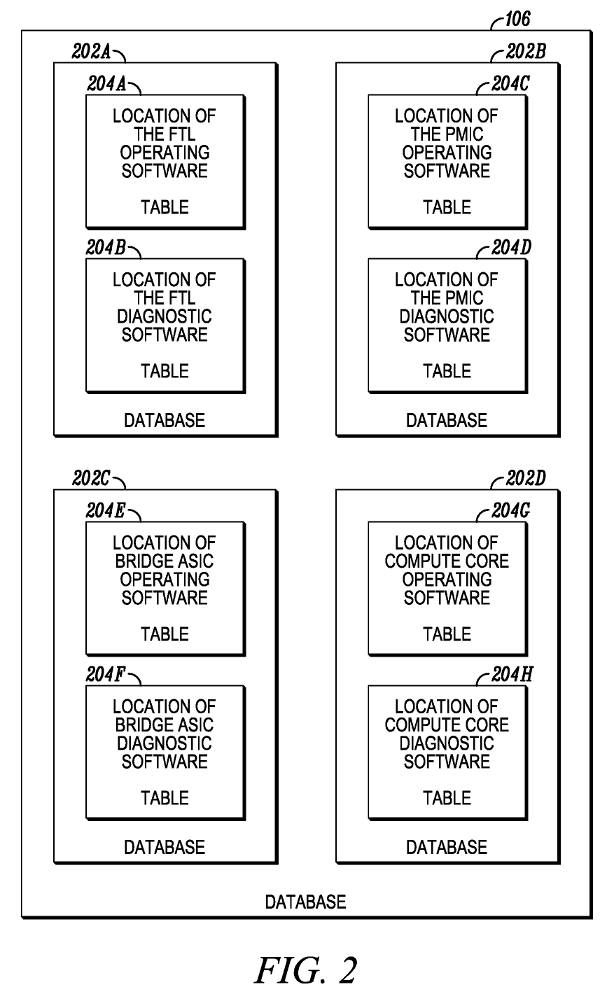

FIG. 2 is another block diagram of an EEPROM used in accordance with some implementations. EEPROM 106 may include multiple databases 202a-202d (referred to herein as databases 202), each of which may include one or more tables 204a-204h that point to locations of operating firmware and diagnostic firmware associated with an independent module. For example, database 202a may include table 204a that points to the location of the FTL operating firmware or includes the FTL operating firmware and table 204b that points to the location of the FTL diagnostic firmware or includes the FTL diagnostic firmware. Database 202b may include table 204c that points to the location of the PMIC operating firmware or includes the PMIC operating firmware and table 204d that points to the location of the PMIC diagnostic firmware or includes the PMIC diagnostic firmware. Database 202c may include table 204e that points to the location of the bridge ASIC operating firmware or includes the bridge ASIC operating firmware and table 204f that points to the location of bridge ASIC diagnostic firmware or includes the bridge ASIC diagnostic firmware. Database 202d may include table 204g that points to the location of a compute core operating firmware or includes the compute core firmware and table 204h that points to the location of the compute core diagnostic firmware or includes the diagnostic compute core firmware. FIG. 2 is provided as an example. Other examples may differ from what is described in FIG. 2.

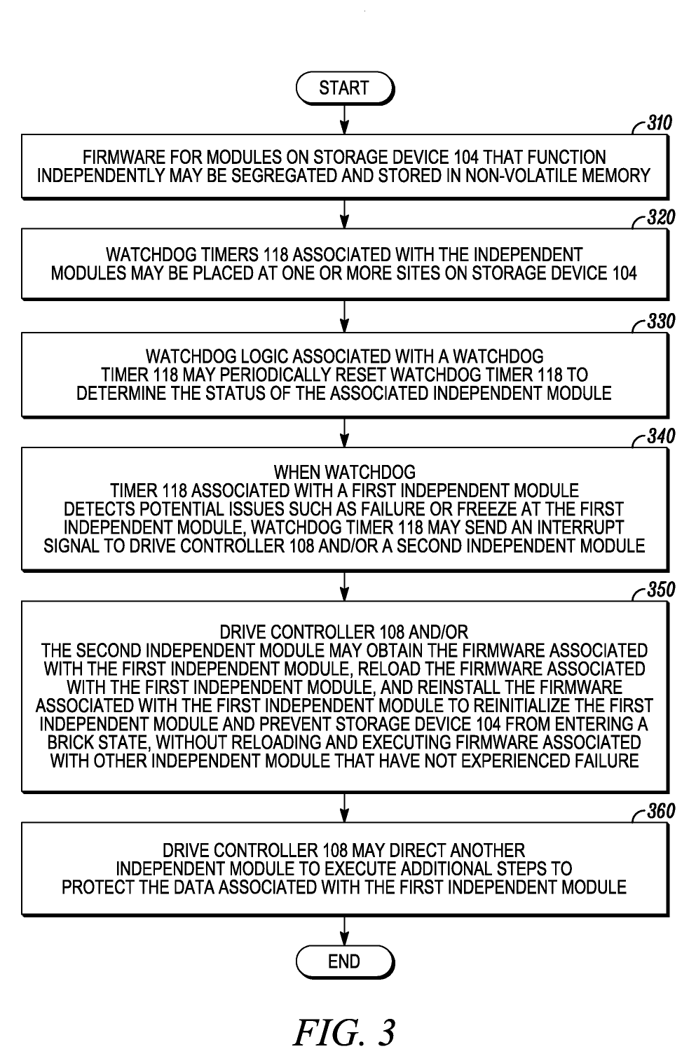

FIG. 3 is an example flow diagram for recovering from failure at an independent module on a storage device used in accordance with some implementations. At 310, firmware for modules on storage device 104 that function independently may be segregated and stored in non-volatile memory. At 320, watchdog timers 118 associated with the independent modules may be placed at one or more sites on storage device 104. At 330, watchdog logic associated with a watchdog timer 118 may periodically reset watchdog timer 118 to determine the status of the associated independent module. At 340, when watchdog timer 118 associated with a first independent module detects potential issues such as failure or freeze at the first sub independent module, watchdog timer 118 may send an interrupt signal to drive controller 108 and/or a second independent module. At 350, drive controller 108 and/or the second independent module may obtain the firmware associated with the first independent module, reload the firmware associated with the first independent module, and reinstall the firmware associated with the first independent module to reinitialize the first independent module and prevent storage device 104 from entering a brick state, without reloading and executing firmware associated with other independent module that have not experienced failure. At 360, drive controller 108 may direct another independent module to execute additional steps to protect the data associated with the first independent module. FIG. 3 is provided as an example. Other examples may differ from what is described in FIG. 3.

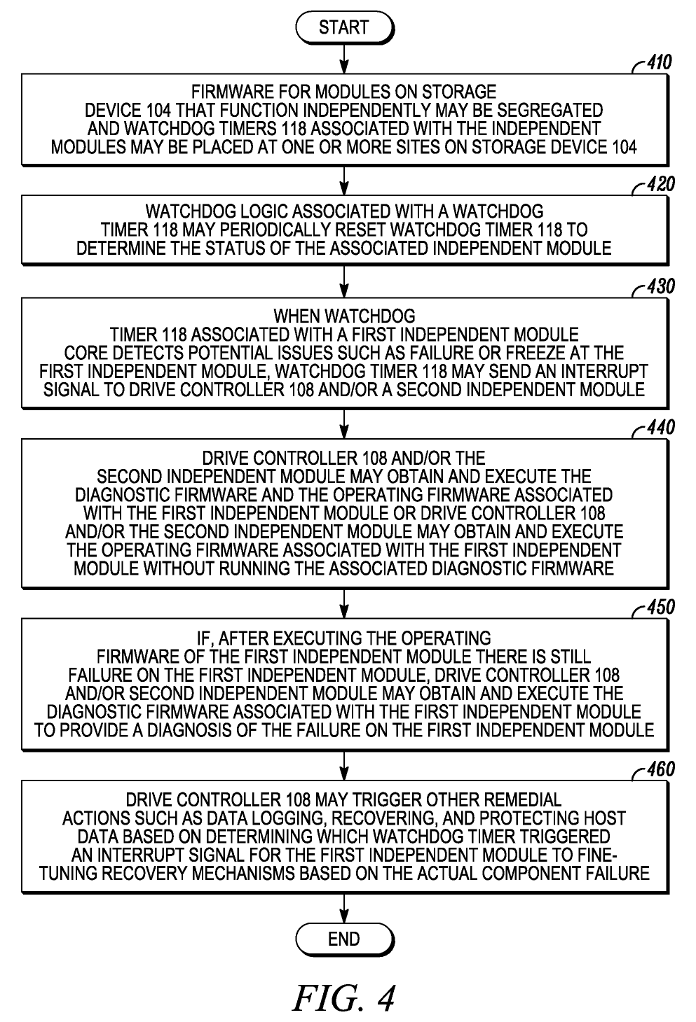

FIG. 4 is an example flow diagram for diagnosing failure at an independent module on a storage device used in accordance with some implementations. At 410, firmware for modules on storage device 104 that function independently may be segregated and watchdog timers 118 associated with the independent modules may be placed at one or more sites on storage device 104. At 420, watchdog logic associated with a watchdog timer 118 may periodically reset watchdog timer 118 to determine the status of the associated independent module. At 430, when watchdog timer 118 associated with a first independent module core detects potential issues such as failure or freeze at the first independent module, watchdog timer 118 may send an interrupt signal to drive controller 108 and/or a second independent module. At 440, drive controller 108 and/or the second independent module may obtain and execute the diagnostic firmware and the operating firmware associated with the first independent module, or drive controller 108 and/or the second independent module may obtain and execute the operating firmware associated with the first independent module without running the associated diagnostic firmware. At 450, if, after executing the operating firmware of the first independent module there is still failure on the first independent module, drive controller 108 and/or second independent module may obtain and execute the diagnostic firmware associated with the first independent module to provide a diagnosis of the failure on the first independent module. At 460, drive controller 108 may trigger other remedial actions such as data logging, recovering, and protecting host data based on determining which watchdog timer triggered an interrupt signal for the first independent module to fine-tuning recovery mechanisms based on the actual component failure. FIG. 4 is provided as an example. Other examples may differ from what is described in FIG. 4.

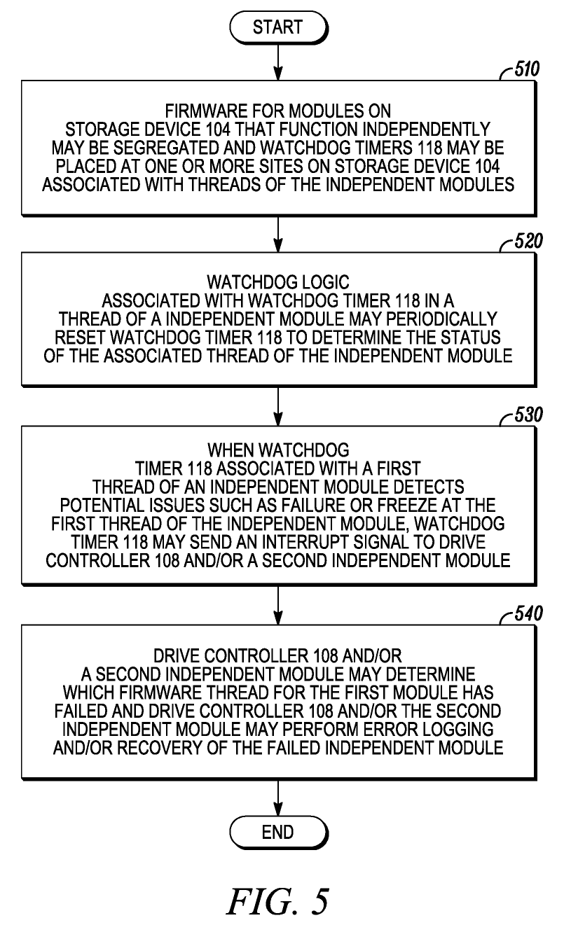

FIG. 5 is an example flow diagram for determining which thread of an independent module has a failure in accordance with some implementations. At 510, firmware for modules on storage device 104 that function independently may be segregated and watchdog timers 118 may be placed at one or more sites on storage device 104 associated with threads of the independent modules. At 520, watchdog logic associated with watchdog timer 118 in a thread of a independent module may periodically reset watchdog timer 118 to determine the status of the associated thread of the independent module. At 530, when watchdog timer 118 associated with a first thread of an independent module detects potential issues such as failure or freeze at the first thread of the sub-component/compute core, watchdog timer 118 may send an interrupt signal to drive controller 108 and/or a second independent module. At 540, drive controller 108 and/or the second independent module may determine which firmware thread for the first module has failed and drive controller 108 and/or the second independent module may perform error logging and/or recovery of the failed independent module. FIG. 5 is provided as an example. Other examples may differ from what is described in FIG. 5.

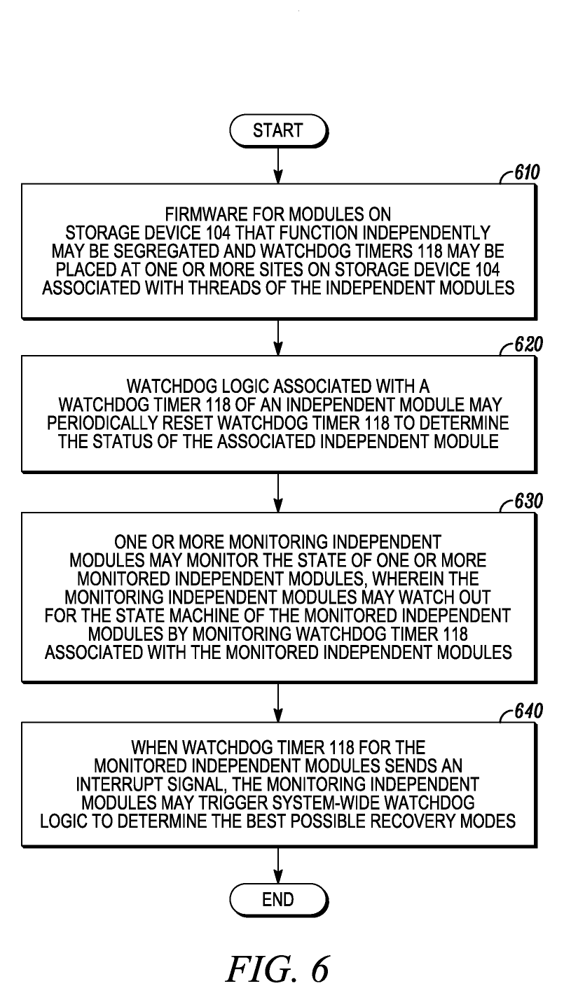

FIG. 6 is an example flow diagram for resolving inter-dependency among the sub-components in accordance with some implementations. At 610, firmware for sub-components or compute cores on storage device 104 that function independently may be segregated and watchdog timers 118 may be placed at one or more sites on storage device 104 associated with the sub-components or compute cores. At 620, watchdog logic associated with a watchdog timer 118 of a sub-component or compute core may periodically reset watchdog timer 118 to determine the status of the associated sub-component or compute core. At 630, one or more monitoring sub-components may monitor the state of one or more monitored sub-components, wherein the monitoring sub-components may watch out for the state machine of the monitored sub-components by monitoring watchdog timer 118 associated with the monitored sub-components. At 640, when watchdog timer 118 for the monitored sub-components sends an interrupt signal, the monitoring sub-components may trigger system-wide watchdog logic to determine the best possible recovery modes. FIG. 6 is provided as an example. Other examples may differ from what is described in FIG. 6.

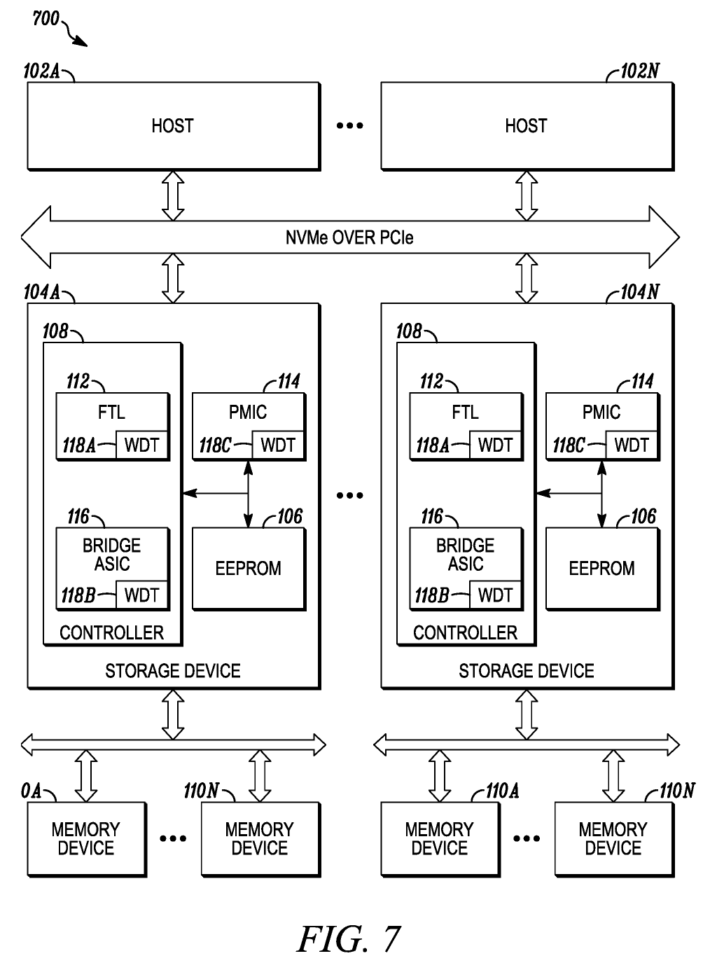

FIG. 7 is a diagram of an example environment in which systems and/or methods described herein are implemented. As shown in FIG. 7, Environment 700 may include hosts 102-102n (referred to herein as host(s) 102), and one or more storage devices 104a-104n (referred to herein as storage device(s) 104). Drive controller 108 may diagnose failure at an independent module on storage device 104 and reset the independent module without resetting other independent modules on storage device 104. Hosts 102 and storage devices 104 may communicate via Non-Volatile Memory Express (NVMe) over peripheral component interconnect express (PCI Express or PCIe), SD, or the like.

Devices of Environment 700 may interconnect via wired connections, wireless connections, or a combination of wired and wireless connections. For example, the network in FIG. 7 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of Environment 700 may perform one or more functions described as being performed by another set of devices of Environment 700.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, or “contains …a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to recover a first module without affecting other modules, the storage device comprises:
a plurality of independent modules with at least one associated watchdog timer;
a memory to store firmware associated with independent modules separately; and
at least one of a drive controller and a second independent module to
receive an interrupt signal from a watchdog timer associated with a first independent module,
determine that failure occurred on the first independent module and that the first independent module has to be reinitialized,
reflash firmware associated with the first independent module to recover the first independent module from a failure state without reloading and executing firmware associated with other independent modules that have not experienced failure.

2. The storage device of claim 1, wherein the memory includes a firmware table to provide a location for the firmware associated with an independent module.

3. The storage device of claim 1, wherein the firmware stored in the memory includes at least one of an operating firmware and a diagnostic firmware for an independent module, wherein the diagnostic firmware collects details of failure at the independent module.

4. The storage device of claim 1, wherein the watchdog timer is periodically reset to determine a status of a microcontroller program on the first independent module.

5. The storage device of claim 1, wherein when the watchdog timer determines failure at the first independent module, the watchdog timer sends the interrupt signal to at least one of the drive controller and the second independent module.

6. The storage device of claim 1, wherein at least one of the drive controller and the second independent module obtains firmware associated with the first independent module from the memory, reloads the firmware associated with the first independent module, and executes the firmware associated with the first independent module to reinitialize the first independent module and prevent the storage device from entering a brick state.

7. The storage device of claim 1, wherein at least one of the drive controller and the second independent module obtains and initializes diagnostic firmware associated with the first independent module prior to initializing operating firmware associated with the first independent module.

8. The storage device of claim 1, wherein at least one of the drive controller and the second independent module
obtains and initializes operating firmware associated with the first independent module,
determines that the first independent module remains in the failure state, and
obtains and initializes diagnostic firmware associated with the first independent module.

9. The storage device of claim 1, wherein the first independent module runs multiple threads, with each thread associated with a thread watchdog timer and the drive controller determines which thread watchdog timer triggered the interrupt signal for the first independent module and the drive controller triggers remedial actions based on the thread watchdog timer that triggered the interrupt signal for the first independent module.

10. The storage device of claim 1, wherein the drive controller determines that a failure occurred on the first independent module and directs the second independent module to protect data associated with the first independent module.

11. The storage device of claim 1, wherein at least one of the drive controller and the second independent module monitor a state of the first independent module and trigger system-wide watchdog logic to determine a recovery mode for the first independent module when the watchdog timer sends the interrupt signal.

12. A storage device to recover a first module without affecting other modules, the storage device comprises:
a plurality of independent modules with at least one associated watchdog timer;
a memory to store firmware associated with independent modules separately; and
at least one of a drive controller and a second independent module to
receive an interrupt signal from a watchdog timer associated with a first independent module,
determine that failure occurred on the first independent module, and
one of reset and reflash at least one of an operating firmware and a diagnostic firmware for the first independent module to recover the first independent module from a failure state without reloading and executing firmware associated with other independent modules that have not experienced failure.

13. A method in a storage device for recovering a first module without affecting other modules, the storage device at least one of a drive controller and a second independent module to execute the method comprising:
receiving an interrupt signal from a watchdog timer associated with a first independent module,
determining that failure occurred on the first independent module and that the first independent module has to be reinitialized, and
reflashing firmware associated with the first independent module to recover the first independent module from a failure state without reloading and executing firmware associated with other independent modules that have not experienced failure.

14. The method of claim 13, further comprising obtaining firmware associated with the first independent module from memory, reloading the firmware associated with the first independent module, and executing the firmware associated with the first independent module to reinitialize the first independent module and prevent the storage device from entering a brick state.

15. The method of claim 13, further comprising obtaining and initializing diagnostic firmware associated with the first independent module prior to initializing operating firmware associated with the first independent module.

16. The method of claim 13, further comprising
obtaining and initializing operating firmware associated with the first independent module,
determining that the first independent module remains in a failed state, and
obtaining and initializing diagnostic firmware associated with the first independent module.

17. The method of claim 13, further comprising determining, by the drive controller, which thread watchdog timer triggered the interrupt signal for the first independent module and triggering remedial actions based on the thread watchdog timer that triggered the interrupt signal for the first independent module.

18. The method of claim 13, further comprising determining, by the drive controller, that failure occurred on the first independent module and directing the second independent module to protect data associated with the first independent module.

19. The method of claim 13, further comprising monitoring, by at least one of the drive controller and the second independent module, a state of the first independent module and triggering system-wide watchdog logic to determine a recovery mode for the first independent module when the watchdog timer sends the interrupt signal.

20. The method of claim 13, further comprising receiving, by at least one of the drive controller and the second independent module, the interrupt signal from the watchdog timer after the watchdog timer determines failure at the first independent module.
